(19) United States
(12) Patent Application Publication
(10) Pub. No.: US 2011/0283089 A1
(43) Pub. Date: Nov. 17, 2011

(54) MODULARIZED MICRO PROCESSOR DESIGN

(76) Inventor: Harshal Ingale, Nashik (IN)

(21) Appl. No.: 13/146,044

(22) PCT Filed: Aug. 10, 2009
(86) PCT No.: PCT/IN09/00448

§ 371 Date: Jul. 25, 2011

(30) Foreign Application Priority Data
Jan. 28, 2009 (IN) 184/CHE/2009

(51) Int. Cl. G06F 9/30; G06F 9/06; G06F 15/76

(52) U.S. Cl. 712/30; 712/32; 712/205; 712/216; 712/E09.003; 712/E09.016

(57) ABSTRACT

A method and system of modularized design for a microprocessor are disclosed. Embodiments disclose modularization techniques, whereby the overall design of the execution unit of the processor is split into different functional modules. The modules are configured to function independent of each other. The microprocessor comprises different components such as a cache logic (201), a clock generation unit (202), a dispatcher (203), a special asynchronous interface (204), an interrupt unit (205), a register file (206) and a multiplexer unit (207). Temporary storage of data in the register files is eliminated, and thus data fetch latency is eliminated. The asynchronous transfer triggered execution architecture increases speed of execution.

### FIELD OF INVENTION

This invention relates to techniques of designing processing elements and, more particularly but not exclusively, to designing a modularized microprocessor.

### BACKGROUND

Traditionally, due to various technical and/or non-technical restrictions, microprocessors have been designed to be suitable for more general purpose applications. Current designs are the correctives over their predecessors. This makes them not the best solutions for particular applications, and less prepared for change to cater to unforeseen demands. These designs have become faster by the day, with increased level of peripheral integration to increase throughput. However, current designs due to their generic design and lack of speed are limited in scope of usage. Though minor functional modifications would make them ideal for any specified application, due to the “Base of development” over which the microprocessors are built, such minor modifications also require ways to design around.

Also, the inter-industry dependence of software over the processor Instruction Set Architecture (ISA) makes legacy maintenance necessary. When the designers fix over a particular ISA, new tools and software targeting the same are developed. The lifecycle of software being longer than the hardware, it becomes necessary for the instructions set to be maintained over a period of time, which is comparatively longer in context of processor development. Current methodologies involve the specification of ISA, as the initialization of any processor design. The direct implication of the instruction set is the internal micro-architecture. Micro-architecture can be kept partially independent of the instruction set, through techniques like micro-coding. Due to the rare use of complex instructions, it becomes wasteful of the hardware resources to use micro-coding. As a result of the instruction set remaining almost constant over a period of time, the internal optimizations are restricted to a limit defined by ISA. Designers face difficulty to implement innovative solutions to speed up the required operations. Even if a novel technique is to be used; it again becomes costly in terms of hardware complexity to maintain the face-value of the processor to constant.

These restrictions are aggravated with the current design implementation techniques being synchronous in nature, i.e., currently implemented designs are clocked. Synchronous designs face greater problems with clocking techniques, and clock distribution management. This makes any modification more complicated. The other serious problem associated with synchronous designs is consumption of power proportional to the clock frequency. The current trend is towards increasing the clock frequency, in order to increase the throughput. Thus, new techniques are required that can limit power consumption against increase of clock frequency, and increasing hardware complexity. Asynchronous (non-clocked) designs consume less power.

In conventional, Reduced Instruction Set Computer (RISC) or Complex Instruction Set Computer (CISC) architecture designs, data has to always go through the register files, due to which data fetch latency arises. This reduces the speed of execution. In an example, in case of inter dependent instructions the output from the previous instruction is input into the next instruction. The result obtained from the first computation is stored in a storage register, before giving the result as input to the second dependent instruction. This movement of data, between the storage registers increases power consumption. Also, in case of conventional architecture designs, the program code structure is different from the standard and requires new compilers. In addition, there exist binary incompatibility problems in cases of transport triggered mechanisms.

As, too many inter-dependent parameters are involved in the structural design, the process of modifying or rather enhancing the processor architecture is too costly for the designer. Hence, the application complexity is implemented as a pure software solution on a general purpose processor which is fairly easy, but inefficient as compared to specific hardware implementation.

### SUMMARY

These and other aspects of the embodiments herein will be better appreciated and understood when considered in conjunction with the following description and the accompanying drawings.

Method of designing a processor system that is decoupled to modularize structural dependency of functional modules and data-path is disclosed. The processor design providing logical layer and implementation layer. Further each layer may comprise of plurality of architectures. Dependency decoupling logic is provided by two layered ISA and glue logic for the two levels of modularity . . . . The method further comprising managing structural dependency by coding generic ports for modules and changing definition codes which dictate the HDL code. The definition code is a HDL definition code. The method further comprising providing a module plug skeleton to provide hierarchical modularity at class level. Module plug skeleton manages data and control path, and provides dependency decoupling logic to interface plurality of modules where each module is an execution unit in execution block of the processor. Providing a module plug skeleton to provide hierarchical modularity at function level, wherein module plug skeleton manages data and control path, and provides dependency decoupling logic to interface plurality of modules where each module is a function module within an execution unit in execution block of the processor.

The method providing a two level instruction set strategy wherein a first level operation triggered architecture format instruction set is obtained and first level instruction set is converted to a second level modified transfer triggered architecture format resulting in ATTE architecture format instruction set. The execution unit is a processing unit, for performing arithmetic and logical computations on the data and function module is a block within the processing unit, for performing operations on individual instructions simultaneously.

Hierarchical modularity is class based modularity in logical layer is obtained by adding or removing executions units in the execution block of the processor. Hierarchical modularity is function based modularity in logical layer is obtained by adding, removing or modifying functions within the execution unit of the processor. The method wherein the definition codes may be internal to the Hardware Description Language (HDL).

A modularized and asynchronous processor system comprising an asynchronous transfer triggered execution architecture is disclosed. The asynchronous transfer triggered execution architecture based multiplexer further comprising a plurality of processing units, each processing unit further comprising a plurality of functional units, functional units connected through interconnects. The system, wherein the processing unit is an Arithmetic Logic Unit (ALU) or a Digital Signal Processor (DSP). A module addressing logic to encode internal code with address format to identify specific module, where data is to be sent and a buffer logic interfacing each of plurality of ALUs to validate input data and reorganize output data. A dispatch unit further comprising a cache access control module to fetch requested data and to write updated data to cache by processor. Decode module to identify individual instructions, classify instructions by class, detect dependencies among the group of instructions, and encode into an internal format in order to divert input data to appropriate functional units. A dispatch module to dispatch encoded instruction stream to an execution unit; and an operation control module to control operation of all modules in dispatch module.

The system wherein each of plurality of functional units further comprises a plurality of sub functional units, sub functional units connected to the functional units through interconnects and sub functional units are connected to each other functional units through interconnects. Module addressing logic employed in asynchronous transfer triggered execution architecture based execution unit comprising a module addressing logic block to encode the internal code with the address format to identify a module where data is to be sent. Plurality of functional modules to operate on the data received by the module addressing logic. An asynchronous transfer triggered execution architecture based execution unit comprising of processing units, each processing unit further comprising of functional units, connected through interconnects. The module addressing logic to encode internal code with address format to identify specific module where data is to be sent and a buffer logic interfacing each processing unit to validate input data and reorganize output data. Method of converting OTA instruction format into modified TTA instruction format resulting in ATTE instruction format, the method comprising fetching the instruction to the addressing logic module in OTA format, encoding the fetched instructions and identifying the function unit for sending the data.

Method of validating input data and triggering operation in asynchronous transfer triggered execution architecture based execution unit, method comprising saving input in a pre-defined input data buffer on change of input, comparing input with saved input data at the edge of validity signal to check if input is changed. When the input is changed, method further comprising updating pre-defined input data buffer with changed input data, passing on changed input data to a functional module, saving result in the result buffer and passing out the result, when output of functional module changes, and indicating completion of operation using completion signal. When the input is not changed, passing out result from previous operation already saved in the result buffer and indicating completion of operation using completion signal. An internal instruction set format for the asynchronous transfer triggered architecture and the format further comprising an ALU code for specifying an address code of the ALU for sending the instruction group, a plurality of FU codes for addressing one or more functional unit within the ALU for sending data. ALU dependency decoder for the asynchronous triggered architecture and decoder comprising performing a check for dependencies between instruction groups sent to a plurality of ALU'S and encoding the instruction stream with dependency codes for dependencies between instruction groups. The encoding of instruction stream is defined by execution mode set by the user.

### BRIEF DESCRIPTION OF THE FIGURES

Some embodiments of apparatus and/or methods in accordance with embodiments of the present invention are now described, by way of example only, and with reference to the accompanying drawings, in which:

FIG. 1 is a block diagram of a processor illustrating inter-architecture dependency in conventional designs;

FIG. 2 illustrates over all architecture of the processor, according to embodiments as disclosed herein;

FIG. 3 illustrates logical representation of hierarchical modularity, according to embodiments as disclosed herein;

FIG. 4 illustrates the module plug for the processor, according to embodiments as disclosed herein;

FIG. 5 illustrates the block diagram of over all architecture of the execution unit, according to embodiments as disclosed herein;

FIG. 6 illustrates the block diagram of execution logic block, according to embodiments as disclosed herein;

FIG. 7 illustrates the internal instruction set for addressing modular structure of ATTE architecture, according to embodiments as disclosed herein;

FIG. 8 illustrates the format of addressing in ATTE architecture, according to embodiments as disclosed herein;

FIG. 9 illustrates the glue logic employed around the functional modules, according to embodiments as disclosed herein;

FIG. 10 illustrates the logical diagram of a dispatcher, according to embodiments as disclosed herein;

FIG. 11 illustrates cache access control architecture, according to embodiments as disclosed herein;

FIG. 12 illustrates the block diagram of fetch unit, according to embodiments as disclosed herein;

FIG. 13 illustrates the block diagram of decode unit, according to embodiments as disclosed herein;

FIG. 14 illustrates the architecture of register file, according to embodiments as disclosed herein; and

FIG. 15 illustrates the block diagram of a direction multiplexer, according to embodiments as disclosed herein.

### DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

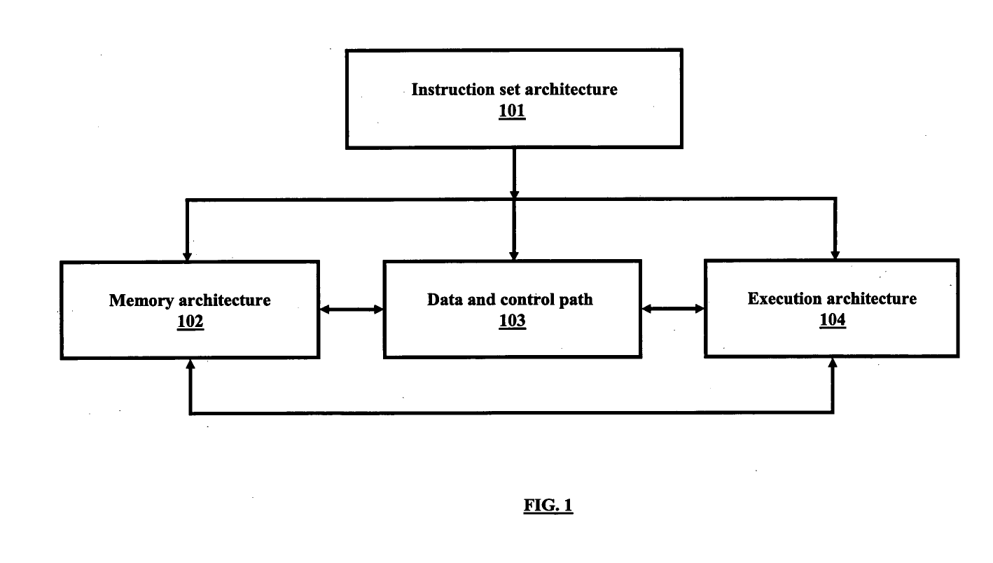

The embodiments herein achieve a modularize microprocessor, by breaking down the overall design into configurable, and independent modular blocks. Referring now to the drawings, and more particularly to FIGS. 1 through 15, where similar reference characters denote corresponding features consistently throughout the figures, there are shown embodiments.

### Inter-Architecture Dependency

FIG. 1 is a block diagram of a processor illustrating inter-architecture dependency in conventional designs. Processors based on conventional designs comprise of instruction set architecture 101, memory architecture 102, execution architecture 104 and data-path and control architecture 103.

Instruction set architecture (ISA) 101, is the part of the computer architecture related to programming, including the native data types, instructions, registers, addressing modes, memory architecture, interrupt and exception handling, and external I/O. An ISA 101 includes a specification of the set of op-codes (machine language), the native commands implemented by a particular CPU design. Instruction set architecture 101 is distinguished from the micro-architecture, which is the set of processor design techniques used to implement the instruction set. Computers with different micro-architectures can share a common instruction set. For example, the Intel Pentium and the AMD Athlon implement nearly identical versions of the x86 instructions set, but have radically different internal designs.

Memory architecture 102 depicts the organization of different components of the memory. The organization of different components such as Random Access Memory (RAM), Read Only Memory (ROM), registers, buffers and so on are a part of memory architecture 102.

Data and control path architecture 103 handles different control functions of the processor. Handling of data such as assigning temporary registers to store the data and process control functions are performed by Data and control path architecture 103.

Execution architecture 104 involves different components of the processor, which are involved in the execution process. The execution unit is sub divided into various functional units called processor modules, to facilitate independent execution of instructions.

Without making changes in the ISA implementation techniques, it is impossible to achieve the desired modularity in the logical layer. Conventional designs use operation triggered ISA format, that is the instructions tells “what to do” with the data accompanied. For the data to be operated upon the instruction is to be decoded and the data sent to appropriate units. Sending the data to the designated units is not enough as each unit may carry out multiple operations and it is then necessary to specify the operation through another encoding. The fixing of such encodings for the operation results in fixing the address of the particular unit which performs the operation permanently for the given implementation. This makes it difficult for the designer to modify or add functional units to enhance specification.

Inter architecture dependencies can be eliminated through hybridization techniques. Hybridization can be achieved by modularity. Hybridization technique is employed in two layers, one at the dispatcher level and other at the execution unit level. At the logical layer of the processor, two levels of modularity is adapted i.e., class based modularity and function based modularity. Class based modularity is achieved at the level of execution units of the processor. In class based modularity, it is possible to add multiple execution units in the execution block of the processor. Class based modularity is a technique to decouple inter architecture dependencies. Function based modularity is achieved within the execution unit of the processor. In function based modularity, it is possible to add or remove functions within an execution unit of the processor. In case of logical layer, the three architectures viz., memory architecture 102, data and control path 103 and execution architecture 104 are completely dependent on instruction set architecture 101. Memory architecture 102 and execution architecture 104 have partial dependencies on the data and control path 103, and between themselves. Due to such dependency, a slight change in one of the architectures may result in change in the other architecture.

### Processor Design

Methods and systems for designing a processor are disclosed. The system employs modularization techniques, whereby the overall design of the execution unit of the processor is split into different functional modules. The functional modules can be any device that processes data or a memory or a reconfigurable Field Programmable Gate Array (FPGA). The functional modules are interconnected through functional and/or structural dependency decoupling logic. Decoupling logic that interconnects functional modules allows auto propagation of any change throughout the design of the processor. Modularization enables to decouple structural dependency between the functional modules and the data path. Structural dependency decoupling is achieved by decoupling two major dependencies; inter layer dependency and inter architecture dependency. The overall processor design is split into two layers i.e., logical layer and the implementation layer. The logical layer further comprises of multiple architectures, which collectively act as macro-definition of the processor. The logical layer comprises Instruction Set Architecture (ISA), Memory architecture, execution architecture and data and control path architecture. The implementation layer comprises micro-architecture of each of logical architectures. Implementation layer achieves the design definition defined by the logical architecture.

Dependency decoupling logic is introduced at two locations; between the design layers and between any two logical architectures. The functional modules in the design are attached together with the logic defined as glue logic. Glue logic acts as dependency decoupling logic, allowing independent enhancements between the functional modules without any functional disruption or structural impact on the design of the processor. Glue logic acts as an abstraction layer between structural and functional requirements of the functional modules. Glue logic interfaces logical layer and implementation layer.

The structural dependency is managed by coding the ports of the module and only changing the definition codes for the hardware description language (HDL). The definition codes are constants defined in any HDL. The definition codes may be internal to the HDL code or may be allied to some other custom interpretable scripts capable of modifying the HLD code. The definition code decouples the structural dependency of the functional module over the data implementation path.

The system employs Asynchronous Transfer Triggered (ATT) architecture in the design of the Arithmetic Logic Unit (ALU) of the processor. The signal/trigger, to transfer the data to the ALU is any external asynchronous signal from some other module within the processor, and not derived from the system clock. This makes the transfer of data to the ALU asynchronous. In case of transfer trigger, the operation to be carried out in the ALU is triggered on transfer of data to the ALU. Transfer triggered execution reduces hardware complexity, protocol signal interpretation logic and the clocking circuits. The module is triggered only when the data is ready, untimely triggering is eliminated. Thus, data integrity is automatically preserved.

### Architecture

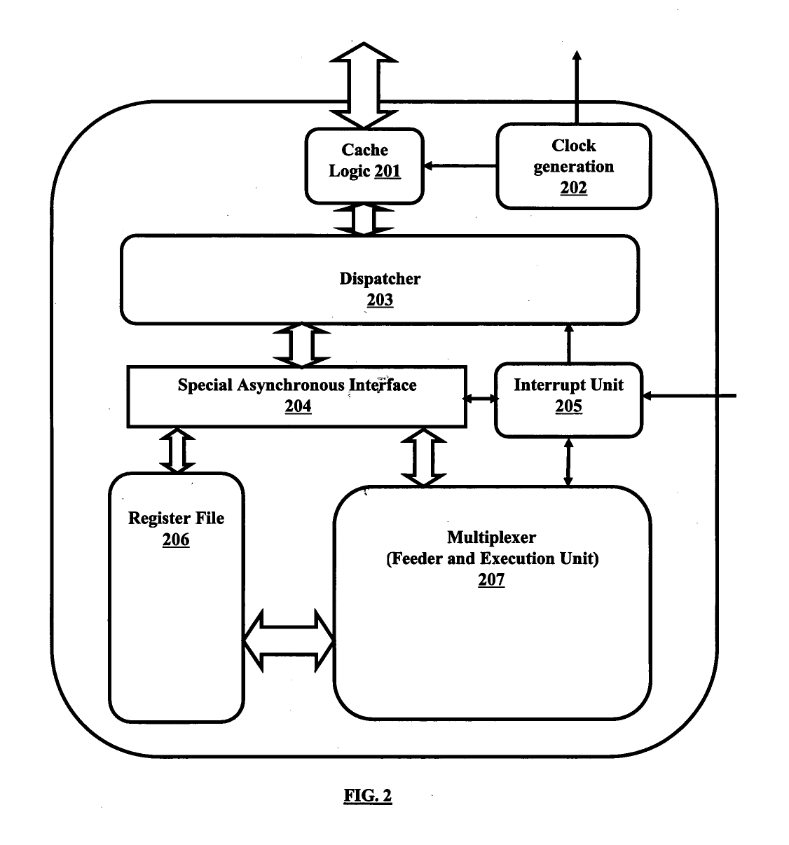

FIG. 2 illustrates over all architecture of the processor, according to embodiments as disclosed herein. The architecture comprises of different components such as cache logic 201, clock generation unit 202, dispatcher 203, special asynchronous interface 204, interrupt unit 205, register file 206 and multiplexer unit 207.

The cache logic 201 is the instruction or data fetching unit of the processor. The cache logic unit 201 interfaces with the main memory of the processor. Depending on the requirements of the design and application, the parameters for the cache logic 201 may be defined. The parameters that can be defined may include organization of a block, which can be defined to be associative. Further, block replacement can be defined as ‘least recently used’ i.e., functional block which is least recently used is either modified or evicted as per the requirement. Write policy can be defined to be in the format of write back or copy back format.

The clock generation unit 202 is used as a reference, to fetch the instructions from the cache logic 201. The clock generation unit 202 uses the system master clock as a reference. The master clock employed as reference is used in order to control the fetch frequency, as the master clock frequency is dynamic. Functionally, the clock generation unit 202 frequency is a scaled version of the master clock frequency.

Dispatcher 203 works in three stages: fetch, decode and dispatch. Dispatcher 203 fetches data from cache logic unit 201, decodes the data, sorts the data in order, according to dependencies and issues the data to a multiplexer 207 on request from the multiplexer 207. Dispatcher 203 refers to specific register memory, in order to fetch valid and required data. On occurrence of any interrupt/exception, dispatcher 203 flushes the current pipeline context and reloads the pipeline as directed by the executing program. Dispatcher 203 is interfaced with the register file 206, cache logic 201 and the special asynchronous bus 204.

The special asynchronous interface unit 205 consists of a set of signals, which comprises the connection between components of the processor, where the transfer of information between the components is organized by the exchange of signals. The signals are not synchronized to the controlling clock. A request signal, from an initiating component indicates the requirement to make a transfer; an acknowledging signal from the responding device indicates the transfer completion. The initiating component may be any module within the processor.

The interrupt unit 205 manages hold/stall of the execution flow of one or more ALUs, at the occurrence of any exception or interrupt signal. The interrupt signal may be an internal interrupt or external interrupt signal. Interrupt unit 205 signals the dispatcher 203 unit, and the multiplexer 207 to stop or/hold the current execution, and flush the instructions in the queue. Interrupt works as a normal interrupt controller.

Register file 206 is an array of processor register, visible or invisible to the users according to the processor state. Registers are used to temporarily store data. Multiple ALUs execute instructions simultaneously. Simultaneous execution increases the through-put of the execution unit. Due to increase in the through-put, the register file 206 is required to have a very high bandwidth.

The multiplexer 207 is responsible for fetching the decoded data, and to issue the calculated operation results to the respective locations. Multiplexer 207 may have a high bandwidth interface to support multiple ALUs/FUs/ELBs. The main functions of multiplexer 207 are propagating the interrupt/exception signals, and interfacing with the register file 206 directly to store the calculated results. The multiplexer 207 has a major control over the execution, as it interfaces the internal execution core with the control and memory architecture.

### Hierarchical Modularity

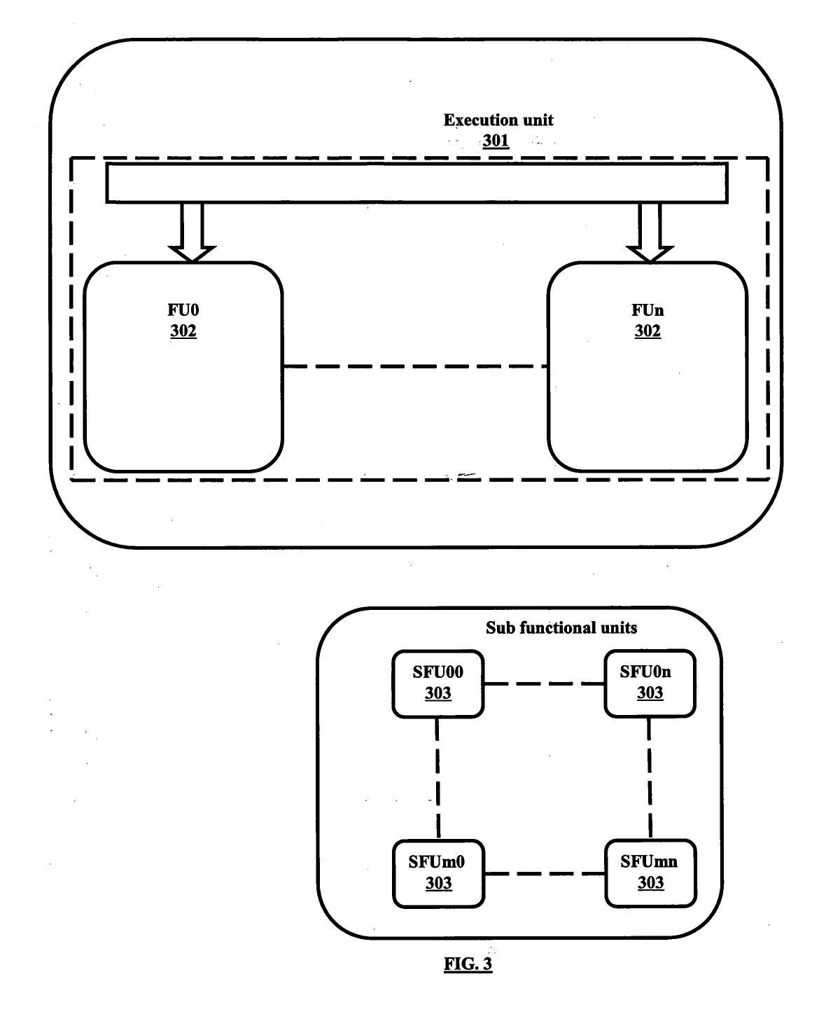

FIG. 3 illustrates logical representation of hierarchical modularity, according to embodiments as disclosed herein. In the embodiment, the processing unit is explained with reference to ALU. However; processing unit can also refer to a Digital Signal Processor (DSP) or the like. At the logical layer of the processor two types of modularity can be achieved, class based modularity and function based modularity. In class based modularity, multiple Execution Units (EU) 301 can be added to the processor. In an example, ALU's 302, DSP co-processors, data encoders, reconfigurable logical blocks etc can be added as the processing unit. On the other hand, function based modularity is achieved at the execution unit 302 level. Modification of the functions within the execution unit such as adding floating point functions or removing single integer function from the ALU is done. To achieve hierarchical modularity the execution unit 301 of the processor is divided into several Functional Units (FU) 302 or ALU's. First level of modularity is achieved in the FU's 302 of the execution units 301. Further, the functional units (FU's) 302 is sub divided into Sub Functional Units (SFU) 303. Second level of modularity is achieved in the SFU 303 of the EU 301.

The FU's 302, are connected to each other through inter connects. Inter connect is a logic, which connects different FU's 302 and handles data transfer between the FU's 302. Any operation can be modulated into a FU 302 and attached to inter connect in order to incorporate the function the module provides. The inter connect adds to the flexibility of customizing operations. Inter-connect is designed to transfer data between any two FUs 302 (even one FU to itself), so that two interdependent instructions are executed one after another immediately without the need to temporarily store the result. By eliminating the step of temporary storage of data in the register, data fetch latency is eliminated and speeds up the execution of the instructions. As there is minimum movement of data from one location to another, power consumption is reduced considerably. The main ALU is divided into modular functional units, as a result of which, the designer can manipulate operations. This adds more flexibility in changing the existing instructions or adding new application specific instructions.

### Module Plug

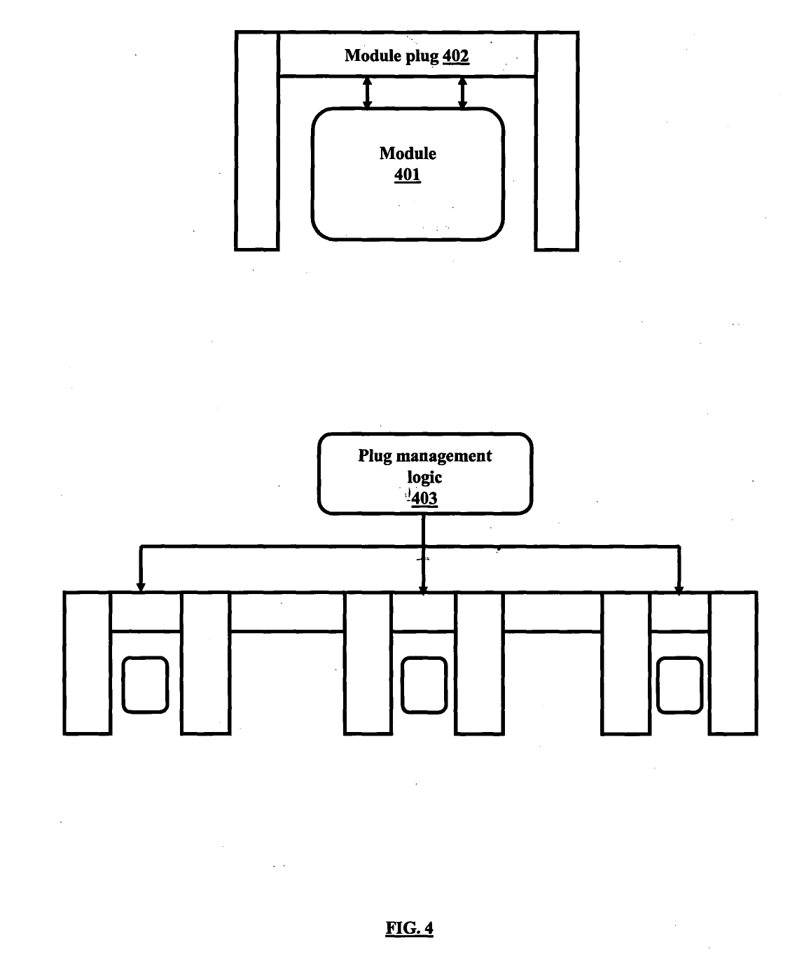

FIG. 4 illustrates the module plug for the processor, according to embodiments as disclosed herein. Hierarchical modularity is implemented in two ways, class based modularity and function based modularity. In class based modularity, addition or deletion of EU's 301 in the execution block of the processor is possible. In function based modularity, addition or deletion of functions within the EU 301 of the processor is possible. Hierarchical modularity is implemented as an empty skeleton called as ‘module plug’. Different modules can be plugged as per the design requirements. The module skeleton includes glue logic, which saves the inclusion of decoupling interface in every module designed. The skeleton has two major components i.e., data and control path and glue logic to interface the modules. Data and control path is absorbed in plug management logic. Glue logic 102 is absorbed in the module plug 402.

Depending on the application requirements, additional module plugs 402 can be added to the ALU 301. In order to manage different plug modules 402, plug management logic 403 can be employed. The plug management logic 403 may be absorbed in the overall processor design implementation: Plug management logic 403 handles all the plug modules 402 interfaced together. During data execution process, plug management logic 403 performs the functions of transferring data to the appropriate plug modules 402 to carry out the execution. The module plug 402 skeleton can be implemented in case of class and functional modularity, with some differences in context of operation.

### ATTE Architecture

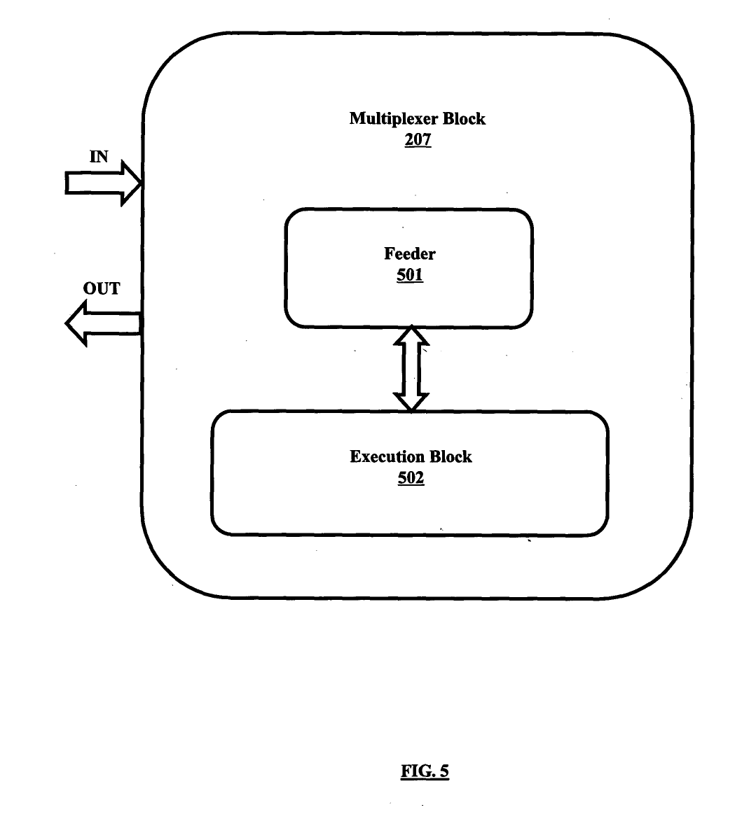

FIG. 5 illustrates the block diagram of over all architecture of the execution unit, according to embodiments as disclosed herein. The feeder 501 and the execution block 502 in the ALU are encapsulated by the multiplexer 207, acting as the execution unit.

The execution Block 502, houses multiple ALUs or FUs 302 or “execution modules”, of various classes of modularity. The number of execution modules employed depends on the memory bandwidth of the processor. The execution block 502 is exclusively responsible for the operations carried out on the data supplied. Various arithmetic and logical computations on the data are performed by the execution unit 502.

The feeder 501 is responsible to queue and supply appropriate data and control signals to all the FU's 302. Feeder 501 also manages the dependencies among two or more FUs 302, and is responsible for exception signaling and flushing the ALU queue. Feeder 501 can manage dependencies among multiple ALUs. The number of ALUs handled by the feeder 501 depends on the data bandwidth of main memory of the processor.

The multiplexer block 207 is responsible for fetching the decoded data, and to issue the calculated operation results to the respective locations. Multiplexer block 207 is provided with very high bandwidth interface to support multiple ALUs/FUs/ELBs. The main functions of multiplexer block 207 may be propagating the interrupt/exception signals and interfacing with the register file 206 directly, to store the calculated results. Multiplexer block 207 interfaces with the dispatcher 203, the interrupt unit 205 and the register file 206. Multiplexer has a major control over the execution process, as the multiplexer 207 interfaces the internal execution core with the control and memory architecture.

Multiplexer block 207 is interfaced to the dispatcher 203. Through the interface, the multiplexer block 207 fetches the data, and codes required to be executed from the dispatcher 203. The dispatcher 203 sends the decoded data on request by the multiplexer block 207, depending on the “execution mode”, which organizes and passes the data to appropriate ALUs/FUs/ELBs.

Multiplexer block 207 is interfaced to the interrupt unit 205. Through the interface, the multiplexer block 207 communicates any exceptions/errors in ALU/FU/ELB operations to the interrupt unit 205. In an example, exceptions/errors could include cases such as, an attempt to divide by zero, overflow, error and so on. External interrupts can also be sensed and serviced appropriately.

Multiplexer block 207 is interfaced to the register file 206. The multiplexer 207 uses this interface to directly store the calculated results in appropriate register locations. Interface may also used to dump the current context onto the registers, in case of any interrupt/exception.

### Execution Logic Block

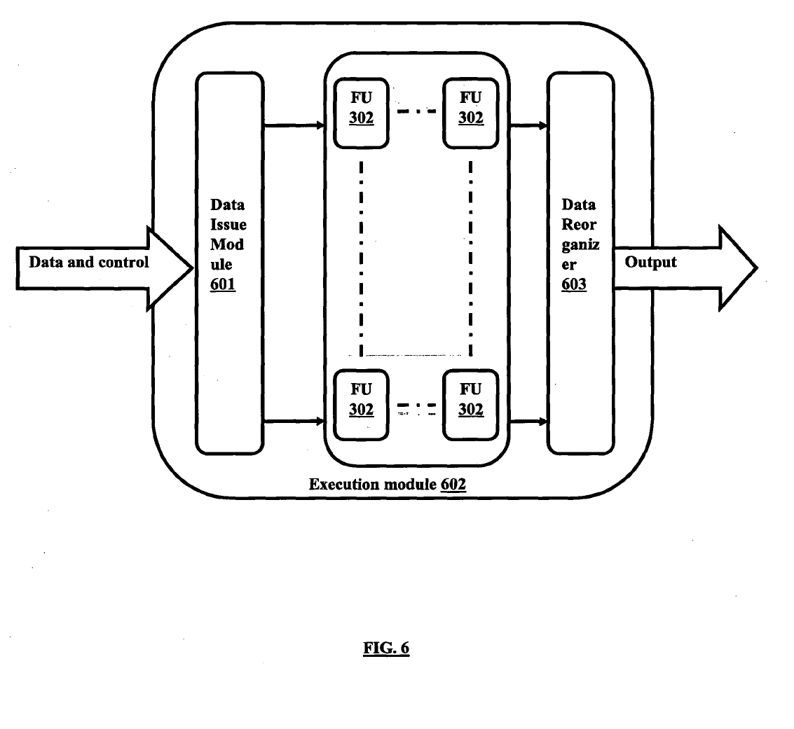

FIG. 6 illustrates the block diagram of execution logic block, according to embodiments as disclosed herein. The execution block 502 is designed on a functionally modular approach. The execution block 502 is composed of data issue module 601, the execution module 602 and data re-organizer 603. The execution module 602 is further divided into functional units (FU's) 302 to increase the speed of execution. The data from the data and control path 103 is sent to the data issue module 601.

The data issue module 601 handles the function of issuing data to the execution module 602. The data issue module 601 issues data to respective FUs 302 based on the control codes. Data issue module 601 directs the data and sets the inter-connect in case of inter-dependent instructions. In an example, for two numbers to be added, data issue module 601 directs the numbers to the addition module, which executes addition on mere transfer of the data. The output obtained from the computation is not stored in the temporary registers, but directly output to the next stage of computation. Considering, the instruction:

X=A+B; (1)

Y=X+D; (2)

On obtaining the instructions (1) and (2), data issue module 601 directs the data to perform step (1) to functional module say 003. Further result ‘X’ obtained from step (1) is used for computing result of step (2) and not stored in temporary register. Hence, the execution time is drastically reduced.

The data from the data issue module 601 is sent to the execution module 602. In the execution module 602, data is sent to the appropriate FU 302, as indicated by the data issue module 601. Any operation can be modulated as a FU 302, and attached to inter-connect in order to incorporate the functionality it provides. This gives the flexibility of customizing operations. An array of FU's 302 is implemented using inter-connects. An inter-connect is designed to transfer data between any two FUs 302 (including from one FU to itself), so that two inter-dependent instructions are executed one after another immediately without the need to temporarily store the result of first computation. The execution time of the processor is saved. The data output from the execution module 602 is sent to the data re-organizer 603.

The data re-organizer 603 on receiving the data from the execution module 602 re-organizes the data. Concurrent execution of independent instructions is carried out in the FU's 302 of the execution module 602. As a result, outputs from the execution module 602 are to be re-organized. The data re-organizer 603 will re-organize the data accordingly and sends the re-organized data to appropriate locations.

### Internal Instruction Set for Addressing Modular Structure of ATTE Architecture

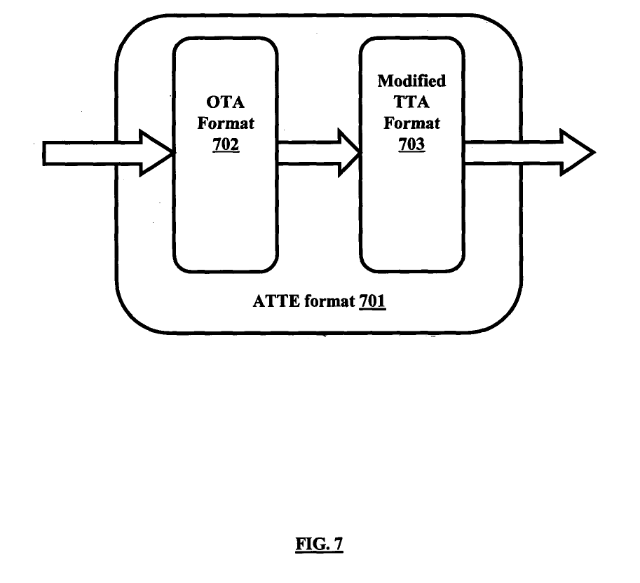

FIG. 7 illustrates the internal instruction set for addressing modular structure of ATTE architecture, according to embodiments as disclosed herein. The embodiment described herein is only an example implementation, and does not aim to limit the scope of the application. TTA format described herein is not the traditional TTA format, however a modified form of the TTA format. To achieve hierarchical modularity a “hybrid two level instruction set strategy” or “execution unit addressing mechanism” may be employed. The overall instruction set format or ATTE architecture format 701 of the processor comprises of a combination of two formats one at the front end and the other at the back end. The front end format is Operation Triggered Architecture (OTA) format 702, and back end format is modified form of the Transfer Triggered Architecture (TTA) format 703.

The front end takes the input in the OTA format 702. In case of OTA format 702, instruction will specify the actual operation to be performed. Further, the operation triggers transport of the operands. The instruction conveys necessary action to be performed on the data. The OTA format 702 is then converted into internal format, specifying, the concerned logic, and the locations where data is to be transported to be operated upon. The data is then passed in the form of modified TTA format 703, which is the internal format.

In case of back end, the input is modified form of TTA format 703. The instruction will specify transport of operands and results requiring the transport to trigger operations on the data. The instruction conveys the location to transport the data, in order to operate on the data. Instruction may be decoded, to determine where the data is to be transported, for the specified operation to be carried out. Effectively, an instruction telling the processor “what to do with the data” is converted into an instruction which tells “where to send the data”.

The combination gives the ATTE format 701. The operation on data is transfer triggered i.e., computation of data is carried out on the transfer of data to the FU 302. The transfer type being asynchronous that requires an external trigger to transfer data from some other module within the processor. The FU's 302 operate independent of each other and are segregated from each other. Transfer control is completely internal controlled by the hardware rather than any program code. Binary incompatibility problems are solved with the ATTE format 701.

### Addressing Logic in ATTE

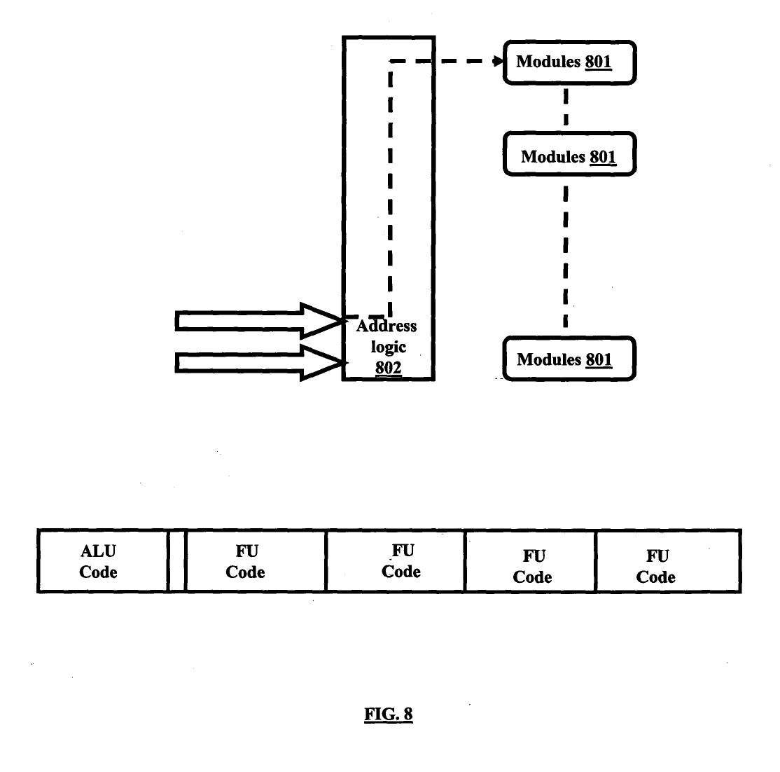

FIG. 8 illustrates the format of addressing in ATTE architecture, according to embodiments as disclosed herein. The execution module performs multiple operations on data supplied to functional modules 301. In order to inform the execution module of exact operation to be carried out, addressing logic 802 mechanism is employed. OTA format 702 employed at the front end is operation triggered. Hence, logic is introduced to address the modules. A structure is devised, where multiple execution modules can be plugged in and assigned location codes to address the modules.

The number of locations for the modules can be decided by the designer as per the design requirements. The modules 801 are assigned different address codes. The addressing logic is designed such that logic block can identify the module 801 to transfer data and send the data to the module 801 identified. In an example, if a computation involves three steps to be performed to obtain the final result. The modules 801 can be configured to carry out the operation concurrently. The addressing logic block 802 assigns the modules to perform the operation. Data is input from data and location block to the addressing logic unit 802. The addressing logic unit 802 decodes the address of the module 801 and sends the data to appropriate module 801. Further, the module 801 performs required operation on the data. Data from the moodule 801 is then sent to the required location. In ATTE format operation triggered mechanism is used, and addressing logic 802 is used to know where to transfer the data. These modules 801 will be a part of processor pipeline rather than being mere attachments on a “local bus”. This will enhance the overall performance and reduce hardware in the processor, as there is no need of bus structure for interfacing new modules.

The instruction format is addressed as Arithmetic Logic Unit (ALU) code and Functional Unit (FU) code. ALU code is the address code of the ALU, where the “instruction group” is to be sent, and FU code is the address code of the functional unit within the already addressed ALU, where the particular data is to be sent. The mechanism of addressing the instructions to particular ALUs and further functional units can be seen as conversion of “instructions” (what to do with the data) to “addresses” (where to send the data). This conversion gives a flexibility to change the processors “instruction set architecture”, while keeping the internals intact.

In an embodiment, three modes of executing instructions can be defined: independent segment execution, partial segment dependence execution and complete segment dependence execution. These modes are classified according to the dependency of the code segments being executed in the ALUs.

In independent segment execution mode, all the code segments being executed are independent of each other. Code segments may be independent processes or threads. The mode provides all the independent threads with user defined resources viz. independent memory space (in case if it is a process), set of context registers etc. The mode is provided for general purpose execution environments.

In partial segment dependence execution, some of the executing segments are dependent. For example, a segment executing in ALU0 is dependent on the segment executing in ALU2. The resources provided for dependent threads are common. They share common memory, context registers etc. The mode may be employed for increasing throughput of a particular process. Throughput can be increased by using two or more ALUs in order to execute the same thread/process.

In complete segment dependence, every segment executing in every ALU is dependent on other segment in some way. In an example, SEG0 in ALU0 is dependent on SEG1 in ALU2; SEG1 in ALU2 is dependent on SEG3 in ALU3; SEG2 in ALU1 is dependent on SEG1 in ALU2 and so on. Further, the modes of execution can be controlled by configuring registers.

### Buffer Logic or Glue Logic

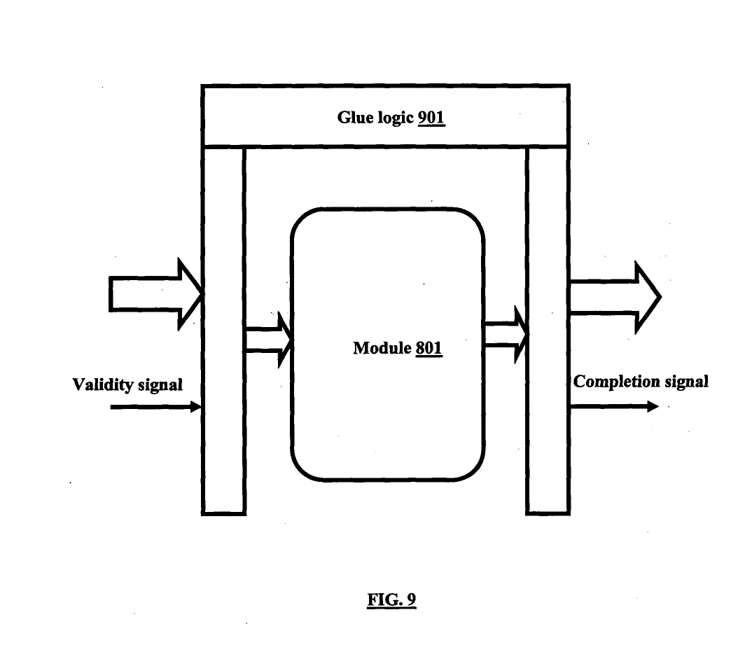

FIG. 9 illustrates glue logic employed around the functional unit, according to embodiments as disclosed herein. In case of synchronous execution mechanisms, validity of the data is indicated by edge of the clock. Whereas in the current processor design, which employs asynchronous mechanisms, logic called as ‘buffer logic’ or ‘glue logic’ is employed to validate data being supplied. Buffer logic acts as wrapper around the module 801. Buffer logic propagates data to and from the modules as it encloses the module 801. The purpose of buffer logic is to sense any change in the input data. Buffer logic senses if the input data is new or is stale, and accordingly passes the data to the module 801. Completion of the operation on the module is sensed by buffer logic and data is passed on the data path. The basic logic implemented by the buffer logic is as follows: when there is a change in the input, new input is saved in a buffer called ‘pre input data buffer’; further at edge of the validity signal, a check is made if input is same as the input data stored in the pre data input buffer. If the input data is new, then data in pre input data buffer is updated, and passed to the module 801 through the interface. On change in the module 801 output, data is saved in the result buffer and data is passed out. A signal then indicates completion of the operation.

### Dispatcher Module

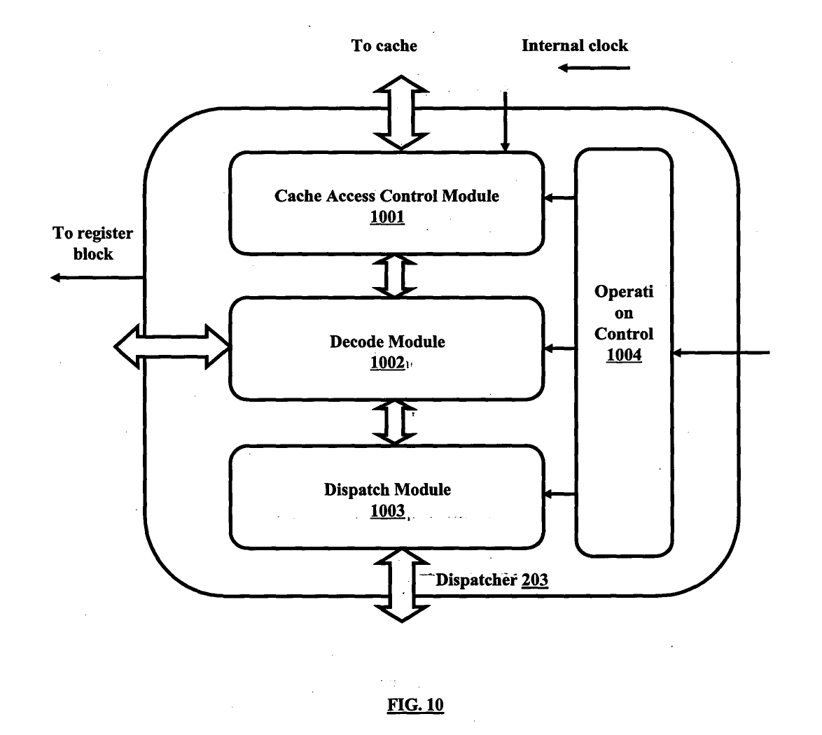

FIG. 10 illustrates the logical diagram of a dispatcher, according to embodiments as disclosed herein. The dispatcher 203 comprises of cache access control module 1001, decode module 1002, dispatch module 1002 and operation and control module 1004. The dispatcher 203 fetches data from cache access control module 1001, decodes the data, sorts the data in order according to dependencies, and issues the data to the multiplexer 207 on request from multiplexer 207. The dispatcher 203 refers to specific register memory, in order to fetch valid and required data. On occurrence of any interrupt/exception, dispatcher 203 flushes the current pipeline context and reloads the pipeline context as directed by executing program.

Cache access control module 1001 is responsible for fetching of requested code/data and writing updated data to the cache 1001 by processor. Cache access control module 1001 refers to output of “Address generate” unit, present in next stage of decode, to ascertain address of the memory to be worked on. The Cache Access Control Module 1001 has three major units; namely Fetch Unit, Throw Unit and Read/write scheduler.

The decode module 1002 is responsible for “primary decode” of instructions. Primary decode identifies individual instructions, classifies the instructions by type/class, detects dependencies among group of instructions and then encodes into an internal format, in order to divert the data to appropriate functional units. The decode module 1002 acts first layer decoder of two layer instruction set strategy of the processor. The decoder module 1002 arranges fetched instructions, in order optimal for execution, generates address for further instructions to be fetched and manages all memory reads and writes.

The data from the decode module 1002 is sent to dispatch module 1003. The dispatch module 1002 dispatches the encoded instruction stream to the execution unit. Dispatch module 1002 holds a copy of the dispatched instruction stream; so that in case of an exception, data in the stream can be rectified if necessary.

Operation and control module 1004 controls operations of all the modules within the dispatcher module 1003 and hence functions of the processor. Operation and control module 1004 is also responsible to control or stall the operations, reset, or preset operation states.

### Cache Access Control Architecture

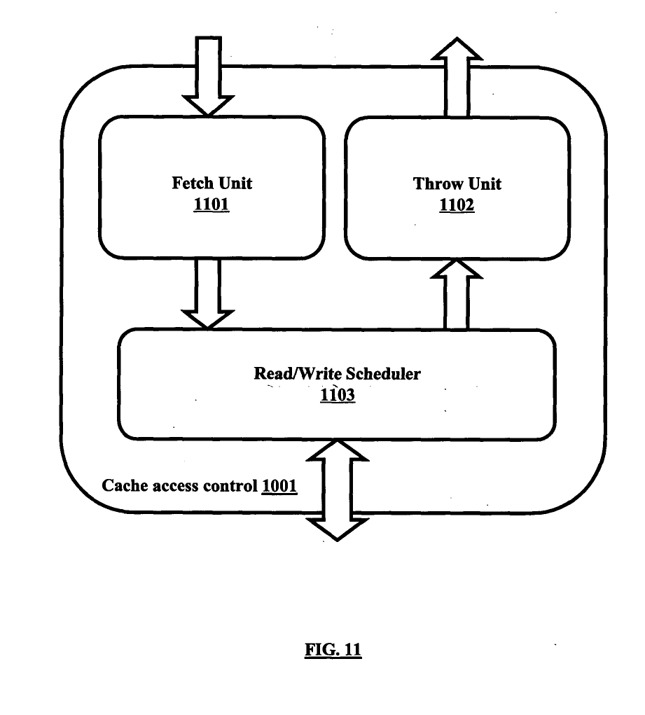

FIG. 11 illustrates cache access control architecture, according to embodiments as disclosed herein. Cache access control module 1001 is responsible for fetching of requested code/data and writing the updated data to the cache 201 by the processor. Cache access control module 1001 refers to output of “Address generate” unit present in the next stage of decode to ascertain address of the memory to be worked on. The Cache Access Control Module 1001 has three major units; namely Fetch Unit 1101, Throw Unit 1102 and Read/write scheduler 1103.

The fetch unit 1101 fetches code/data from cache access control module 1001 as directed by the decoder 1002 control. The number of instructions fetched from the cache access control 1001 depends on the number of ALUs/FUs/ELBs implemented in the execution unit. In an example, for k number of ALUs, fetch unit 1102 fetches at-least 4k instructions as per the synchronization with internal clock. The fetch unit 1102 is synchronized to the internal master clock in order to interface with the memory. The clock frequency is dynamic and changes according to the requirements of data. The fetch unit 1102 also incorporates a local clock with a frequency higher than that of internal master clock frequency. Higher frequency is used in order to eliminate misalignment of the “fetch group”. Hence, fetch unit 1102 works synchronized by two clocks; namely local high frequency clock and internal master clock. The local clock is used to fetch instructions at a higher frequency, in order to avoid misalignment of required number of instructions fetched. Misalignment can cause drastic reduction in throughput of the system.

The throw unit 1102 writes to cache access control module 1001 as directed by the decode unit 1002. The throw unit 1102 comprises of a buffer and control unit. Buffer stores data to be written into the cache 201. Control unit controls operations such as, what data is to be written into which cache 201 unit. The control unit is synchronized by same clock as used by fetch unit 1101. Control unit takes control inputs from decode module 1002.

The read/write scheduler 1103 schedules read and write requests from the processor. As the cache 201 memory can handle only a limited number of requests and processor is much faster than the conventional memories, read requests and write requests need to be scheduled in order to preserve integrity of data.

### Fetch Unit

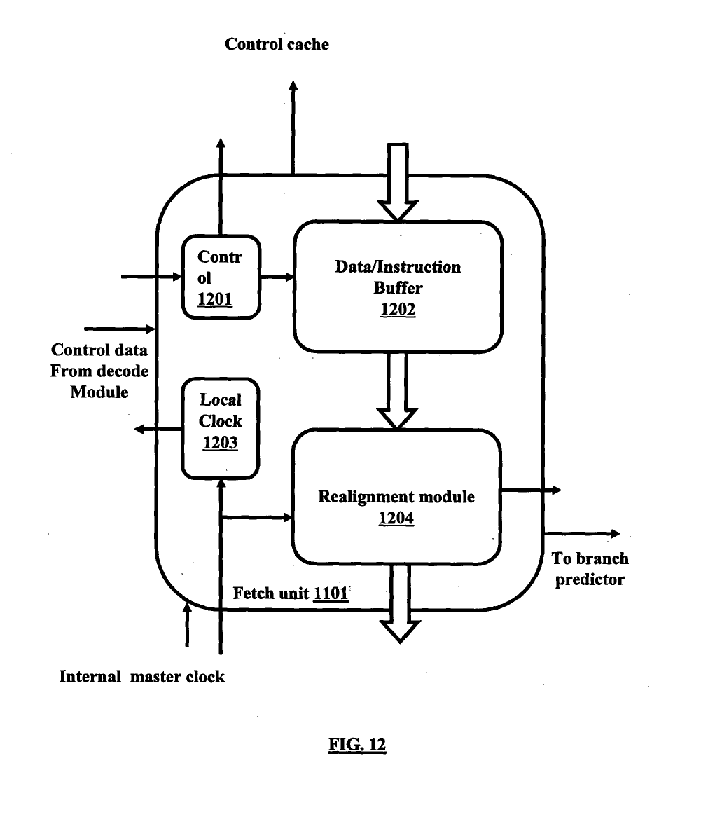

FIG. 12 illustrates the block diagram of fetch unit, according to embodiments as disclosed herein. The fetch unit 1002 fetches code/data from the cache access control module 1001, as directed by the decoder 1002. The number of instructions fetched from cache 201 depends on number of ALUs/FUs/ELBs implemented in the execution unit. In an example, for k number of ALUs, fetch unit 1102 fetches at-least 4k instructions as per the synchronization with internal clock. The fetch unit 1102 is synchronized to internal master clock in order to interface with the memory. The clock frequency is dynamic and changes according to the requirements of data. The fetch unit 1102 also incorporates a local clock, with a frequency higher than that of the internal master clock frequency. Higher frequency is used in order to eliminate misalignment of the fetch group. Hence, fetch unit 1102 works synchronized by two clocks; namely local high frequency clock and internal master clock. The local clock is used to fetch instructions at a higher frequency, in order to avoid misalignment of required number of instructions fetched. Misalignment can cause drastic reduction in throughput of the system. The fetch unit 1102 is composed of four sub-units i.e., control 1201, data/instruction buffer 1202, local clock 1203 and Realignment module 1204.

Control unit 1201, controls what code/data is to be fetched, determined by the input from address generation unit in the decode module 1002. Control unit 1201 is synchronized by a local clock with a higher frequency than internal master clock. Higher frequency is employed to fetch instructions in order; for the instructions to be rearranged into required number of sets called as fetch group.

Data/Instruction buffer 1202 temporarily stores the fetched instructions. The fetched instructions are stored to feed the instructions to the realignment unit 1204. The realignment module 1204 requires more than one set of fetched instructions; hence the buffer has a memory at least double the size of bandwidth of fetch module 1201. Data/Instruction buffer 1202 acts as a wait station for the fetched instructions.

The realignment unit 1204 aligns the fetched instructions, as required by the decoder in order to achieve maximum throughput. Realignment unit 1204 uses internal master clock as a reference like decoder module 1002. Use of same reference clock synchronizes fetch unit 1101 and decode module 1002 through a common clock. Realignment unit 1204 also incorporates an “instruction pre-scan” unit, which scans the aligned instruction groups for conditional instructions. Realignment unit 1204 sends the position of the instruction to branch predictor, so that predictor will work till the instruction is executed. The realignment unit splits the data fetched into two components; “instructions” and “data”.

Local clock 1203 is used as a reference to fetch instructions from the cache 201. The clock uses master clock as a reference. The master clock as a reference is used in order to control fetch frequency, as the master clock frequency is dynamic. Functionally, the local clock 1203 frequency is a scaled version of the master clock.

### Decode Unit

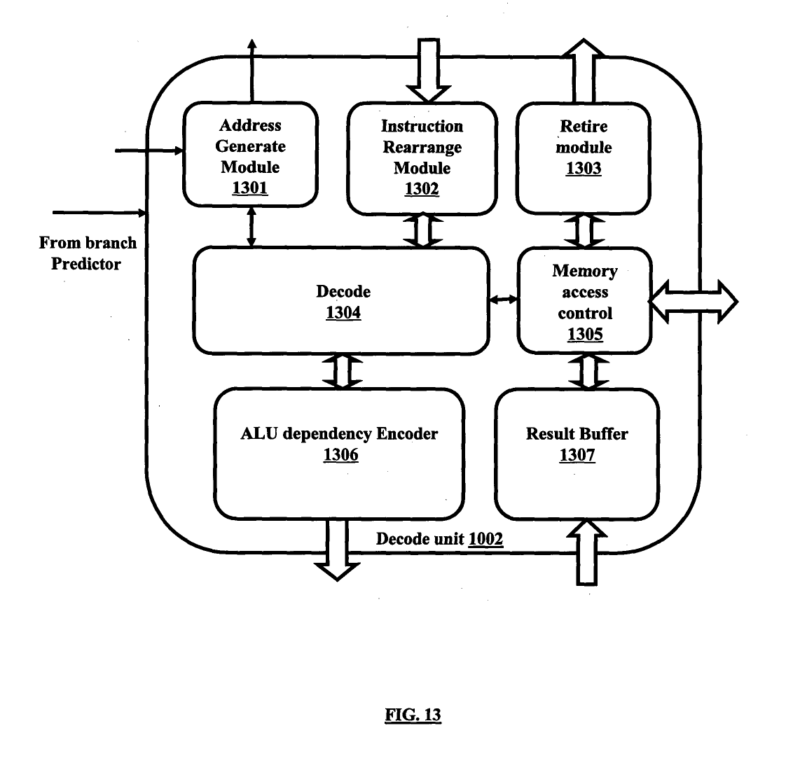

FIG. 13 illustrates the block diagram of decode unit, according to embodiments as disclosed herein. The decode module 1002, arranges the fetched instructions in an order suitable for optimal execution, generates addresses for the instructions to be fetched, decodes the fetched instructions and manages memory read and write operations. The decode module 1002 comprises of sub modules, namely, address generate module 1301, instruction re-arrange module 1302, retire module 1303, decode module 1304, memory access control 1305, ALU dependency encoder 1305 and result buffer 1306.

The address generate module 1301, generates address of the location to fetch requested data. Address of the location to fetch data is generated by referring to special function registers and branch predictor results. The central decode unit 1304 controls the address generation by passing on control data to address decode unit 1301. The address generation dependency is reported by instruction rearrange module 1302.

Instruction re-arrange module 1302, arranges the fetched instructions in order of their dependencies, to achieve maximum throughput. Instruction re-arrange module 1302 pre-decodes the instructions. The pre-decoding mechanism is implemented to detect conditional or address generate dependencies.

The decode module 1304 is the central module, which manages functions including but not limited to: decoding the instructions into internal format so that they can be dispatched to appropriate ALUs, and then to appropriate functional units; operating exceptions, interrupts and overflows; controlling the address generation of next batch of instructions to be fetched, to pre-schedule the retirement of executed results; controlling the memory access control module; and loading/storing memory as instructed.

The ALU dependency encoder 1306, checks for any dependencies between the instructions groups to be dispatched to respective ALUs. If any dependency occurs between two or more groups, instruction stream to the dispatch unit 1003 is encoded with dependency codes. The process further increases throughput, by eliminating the need of any external storage element between consecutive executions of two dependent code segments and effectively increasing the instruction dispatch bandwidth. The execution mode set by the user, defines encoding of instruction stream being dispatched.

The result buffer 1307 is used to store calculated results along with the destination addresses, where result is to be stored. The result buffer 1307 acts as a wait station for the results to be written back to their respective memory locations. The memory organization of result buffer 1307 may be affected by execution modes. The decode module 1304 pre-schedules write operation of the results.

Memory access control module 1305 is responsible for interfacing the decode unit 1305 to all memories. Memory access control module 1305 implements control protocols to write/read from various types of memories viz. register file 206, cache 201, buffers etc (decode unit 1305 only writes to cache 201 through this module, whereas decode unit 1305 reads and writes to register file 206; uses other mechanism to read from cache 201). The decode unit 1304 controls the memory access control 1305 to access memories as required by the process. The source of data for decode module 1304 is either from result buffer 1307 or decode unit 1304.

The retire module 1303 is responsible to dispatch the results to the cache 201.

### Register File

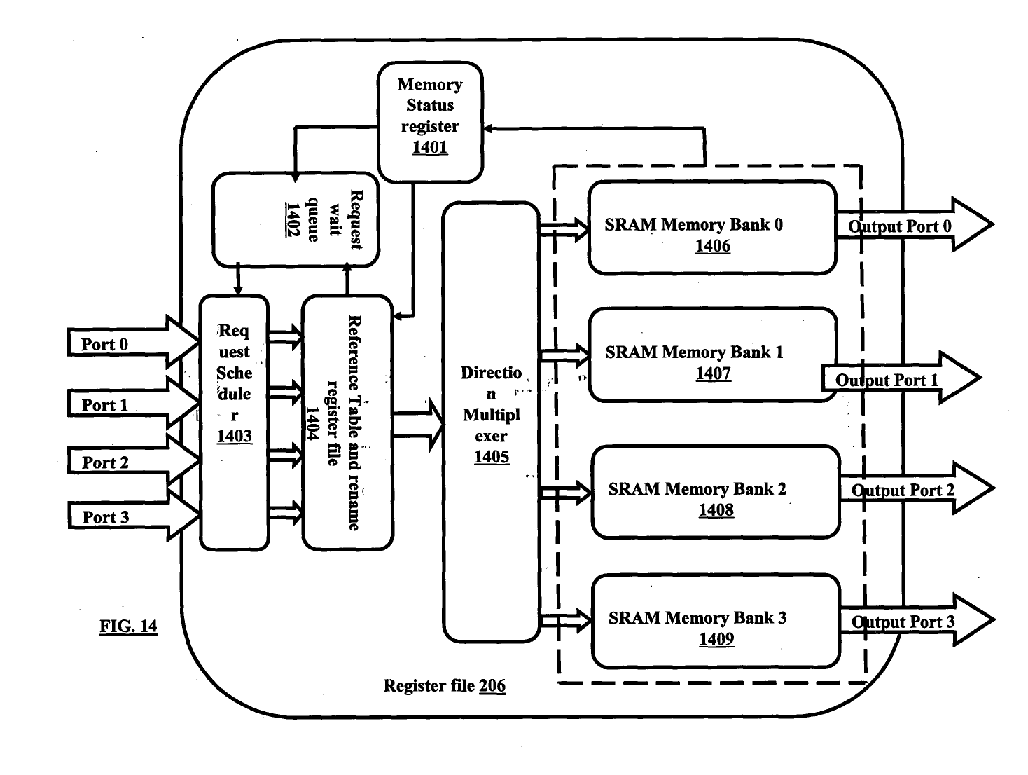

FIG. 14 illustrates the architecture of register file, according to embodiments as disclosed herein. The register 206 is an array of registers, which are used to store the data temporarily. The register file 206 allows reading or writing multiple values simultaneously, reading and writing single value simultaneously and also supports register re-naming. The register file 206 comprises request scheduler 1403, reference table, re-name register 1404, direction multiplexer 1405, request wait queue 1402, memory status register 1401, and a set of SRAM memory blocks (1406, 1407, 1408, and 1409).

The request scheduler 1403 eliminates data hazards. Request scheduler 1403 makes sure the data read/write dependencies are preserved. The execution unit has a high throughput as multiple ALU's are executing instructions simultaneously. Thus, the register file 206 is required to have a very high bandwidth to store the data during execution of instructions. Four ALU's issue four data values of the result at the same time. In order to write the data, data is required to be scheduled due to high degree of instruction level parallelism. As there is concurrent execution of multiple instructions, multiple data writes and reads are required simultaneously, which is not possible due to physical restrictions, which limit the number of SRAM memory blocks implemented. As only four SRAM memory blocks are implemented, the request scheduler 1403 schedules reads and writes, so that only the data read-writes, which can be handled at a time are issued further.

The reference table and re-name register file 1404, maps the architectural register's to actual physical registers. Architecture registers are defined by the ISA. The architecture registers are not implemented as a single (register) memory file. They are implemented as a combination of multiple register files in order to implement some more functionality such as register renaming etc. The reference table and re-name register file 1404, is a cascade of reference table and re-name register. Reference table is the “architected register file” (ARF), which maps the architectural registers into implementation registers. Reference table specifies the exact location of register within the SRAM memory blocks. The inputs to the ARF are four read ports and one write port.

The rename register file 1204 specifies the validity and availability of particular location requested. Rename register file 1404 uses the memory status register to ascertain the status of required memory location to be written or read. If any of the requested locations is busy or is waiting for update, the request is then queued in the “request wait queue” 1402. Rename register file gives context based locations of the registers same names. For example, ALU 1 reads register r1, at the same time ALU3 writes to r1, but both ALUs are executing different codes, so there is a difference between both the registers despite their same names.

The memory status register 1401 stores the current status of all the memory locations (registers) used to implement registers. Memory status register 1401 sets two flags per memory location i.e., Validity and Busy. The validity flag specifies whether the data is valid or not; that is whether it needs an update. Validity flag is set, if the data in the particular location is stale, and not useful to the current request. Busy flag specifies that the requested location is being used i.e., the data is being updated.

The request wait queue 1402 is employed to send the data that is being currently serviced. The request is in wait state unless the condition favorable for the request to be serviced is achieved. The memory status register 1401 acts as a trigger for the waiting request, which is then sent to the request scheduler 1403 to be serviced.

The direction multiplexer 1405, directs the read-write requests to exact locations according to the control codes issued by the previous modules. Direction multiplexer 1505 is used to bridge all the SRAM memory banks so that the face value of the set is a single memory bank. The direction multiplexer 1405 routes the request to the appropriate memory banks.

The Synchronous Random Access Memory (SRAM) consists of four SRAM memory banks, to store the requests sent by the direction multiplexer 1405. The SDRAM locations are used to store the requests to be addressed, while the current request is being executed.

### Direction Multiplexer

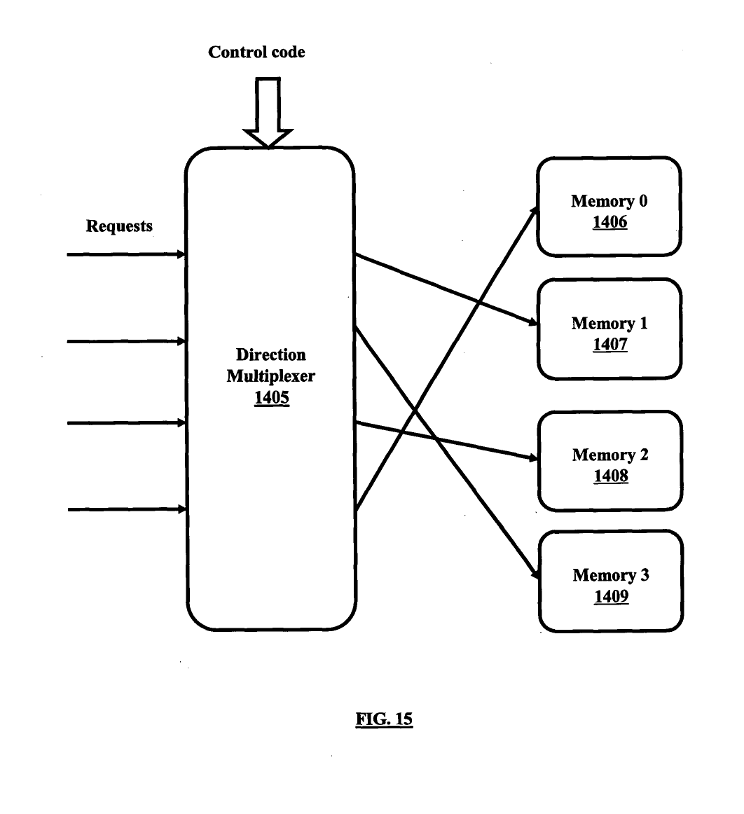

FIG. 15 illustrates the block diagram of a direction multiplexer, according to embodiments as disclosed herein. The direction multiplexer 1405 directs the read-write requests to exact locations according to the control codes issued by previous modules. Multiplexer interfaces the execution unit to the storage registers. Multiplexer fetches data from storage registers and transfers the data to the execution unit at the time of execution. Multiplexer also transfers the computed results from execution unit to registers for temporary storage. Direction multiplexer 1405 is used to bridge all SRAM memory banks, so that the face value of set is a single memory bank. In an example, consider the case wherein the SRAM locations are assigned codes of 001; for SRAM memory bank 0, 002 for SRAM memory bank 1, 003 for SRAM memory bank 2, and 004 for SRAM memory bank 3. If the direction multiplexer 1405 decodes the control code as 003, direction multiplexer will route the request to be stored at memory location of SRAM memory bank 2, while current request is being serviced. The request is stored at the third memory 1408.

The description and drawings merely illustrate the principles of the invention. It will thus be appreciated that those skilled in the art will be able to devise various arrangements that, although not explicitly described or shown herein, embody, the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

What is claimed is:

1. Method of designing a processor system that is decoupled to modularize structural dependency of functional modules and data-path, said method comprising:
providing the processor design with a logical layer and an implementation layer, wherein each layer further comprises of plurality of architectures;
providing dependency decoupling logic between said logical layer and said implementation layer, and between said plurality of architectures within said each of layers; and
decoupling instruction set architecture (ISA) and execution architecture by providing hierarchical modularity.

2. Method as in claim 1, where said dependency decoupling is provided by a two layered instruction set architecture (ISA).

3. Method as in claim 1, said method further comprising managing structural dependency by:
coding generic ports for modules; and
changing definition codes that dictate Hardware Description Language (HDL) code.

4. Method as in claim 1, where said definition code is a HDL definition code.

5. Method as in claim 1, wherein hierarchical modularity is class based modularity in said logical layer.

6. Method as in claim 1, wherein hierarchical modularity is function based modularity in said logical layer.

7. Method as in claim 1, wherein said definition codes are internal to HDL.

8. Method as in claim 1, wherein said definition codes are external to HDL.

9. Method as in claim 1, said method further comprising:
providing a module plug skeleton to provide hierarchical modularity at class level, wherein said module plug skeleton manages data and control path, and provides dependency decoupling logic to interface plurality of modules where each module is an execution unit in execution block of said processor;
providing a module plug skeleton to provide hierarchical modularity at function level, wherein said module plug skeleton manages data and control path, and provides dependency decoupling logic to interface plurality of modules where each module is a function module within an execution unit in execution block of said processor; and
providing a two level instruction set strategy wherein a first level operation triggered architecture format instruction set is obtained and said first level instruction set is converted to a second level modified transfer triggered architecture format resulting in ATTE architecture format instruction set.

10. Method as in claim 9, where a function module is a block within the processing unit for performing operations on individual instructions simultaneously.

11. A modularized and asynchronous processor system, said system comprising:
an asynchronous transfer triggered execution architecture based multiplexer further comprising
a plurality of processing units, each processing unit further comprising a plurality of functional units, said functional units connected through interconnects;
a module addressing logic block to encode internal code with address format to identify specific module where data is to be sent; and
a buffer logic block interfacing each of said plurality of processing units to validate input data and reorganize output data, and
a dispatch unit further comprising
a cache access control module to fetch requested data and to write updated data to cache by said processor;
a decode module to identify individual instructions, classify said instructions by class, detect dependencies among the group of instructions, and encode into an internal format in order to divert input data to appropriate functional units;
a dispatch module to dispatch encoded instruction stream to an execution unit; and
an operation control module to control operation of all modules in said dispatch module.

12. The system as in claim 11, wherein said processing unit is an Arithmetic Logic Unit (ALU).

13. The system as in claim 11, wherein said processing unit is a Digital Signal Processor (DSP), data encoder-decoder, Field Programmable-Gate Array (FPGA).

14. The system as claimed in claim 11, wherein each of said plurality of functional units further comprises:
a plurality of sub functional units, said sub-functional units connected to the functional units through the interconnects; and
said sub functional units are connected to each other functional units through interconnects.

15. The system as in claim 11, wherein said module addressing logic block further comprising:
a plurality of functional modules to operate on the data received by the module addressing logic.

16. An asynchronous transfer triggered execution architecture based execution unit comprising
a plurality of processing units, each processing unit further comprising a plurality of functional units, said functional units connected through interconnects;
a module addressing logic to encode internal code with address format to identify specific module where data is to be sent; and
a buffer logic interfacing each of said plurality of processing units to validate input data and reorganize output data.

17. Method of converting OTA instruction format into modified TTA instruction format resulting in ATTE instruction format, said method comprising:
addressing logic module fetching instruction in OTA format;
identifying function units for sending the data;
obtaining addresses of said identified function units;
addressing logic module encoding said fetched instructions with said obtained addresses; and
sending the data to the functional unit.

18. Method of validating input data and triggering operation in an asynchronous transfer triggered execution architecture based execution unit, said method comprising:
saving input in a pre-defined input data buffer on change of input;
comparing input with said saved input data at the edge of validity signal to check if input is changed;
when the input is changed, said method further comprising
updating said pre-defined input data buffer with changed input data,
passing on said changed input data to a functional module,
saving result in the result buffer and passing out the result, when output of said functional module changes, and
indicating completion of operation using completion signal; and when the input is not changed, said method further comprising
passing out result from previous operation already saved in the result buffer; and
indicating completion of operation using completion signal.

19. An internal instruction set format for the asynchronous transfer triggered architecture and said format further comprising:
an ALU code for specifying an address code of an ALU for sending the instruction group;
a plurality of FU codes for addressing one or more functional unit within the said ALU for sending data.

20. Method of processing dependent instructions in an asynchronous triggered architecture based processor, said method comprising:
performing a check for dependencies between instruction groups sent to a plurality of ALU'S; and
encoding the instruction stream with dependency codes for dependencies between instruction groups.

21. Method as in claim 20, wherein processing said encoded instruction stream, transfer of data between a first function unit and a second function unit does not require storage of result from said first function unit.

22. Method as in claim 20, wherein encoding of instruction stream is defined by execution mode set by the user.
